(19) United States
(12) Patent Application Publication
(10) Pub. No.: US 2013/0139084 A1
(43) Pub. Date: May 30, 2013

(54) METHOD FOR PROCESSING UI CONTROL ELEMENTS IN A MOBILE DEVICE

(71) Applicant: Samsung Electronics Co., Ltd., Suwon-si (KR)

(72) Inventor: Jaebyeong HAN, Yongin-si (KR)

(73) Assignee: SAMSUNG ELECTRONICS CO. LTD., Suwon-si (KR)

(21) Appl. No.: 13/622,125

(22) Filed: Sep. 18, 2012

(30) Foreign Application Priority Data
Nov. 29, 2011 (KR) 10-2011-0125500

(51) Int. Cl. G06F 3/048

(52) U.S. Cl. 715/765

(57) ABSTRACT

A method is provided that processes User Interface (UI) control elements in a mobile device with a touch screen. The method includes: displaying a checkbox; displaying a line according to a user's drawing gesture on the check box; enabling the checkbox if the length of the line is equal to or greater than a preset value; disabling, if the check box has previously been enabled, the checkbox by a user's touch gesture.

### PRIORITY

This application claims the benefit under 35 U.S.C. §119(a) of a Korean patent application filed on Nov. 29, 2011 in the Korean Intellectual Property Office and assigned Serial No. 10-2011-0125500, the entire disclosure of which is hereby incorporated by reference.

### BACKGROUND OF THE INVENTION

1. Field of the Invention

The present invention relates to User Interface (UI) processing methods. More particularly, the present invention relates to a method that processes UI control elements in a mobile device with a touch screen, via drawing gestures.

2. Description of the Related Art

Mobile devices employ a variety of Operating Systems (OSs) (e.g., iPhone, iOS, Windows Mobile 7, Android, Bada, and the like) that support touch screens. The OSs provide User Interface (UI) control elements in fixed shapes. UI control elements serve to execute UI control functions and are implemented with Button, Data & Time picker, Trackbar, checkbox, combobox, and the like. However, UI control elements according to the related art are designed to be shown in a uniform shape and to be selected or released via the same mode.

Mobile devices are controlled via a variety of UIs. Mobile devices provide a character recognition function. Mobile devices sense the presence of touches via stylus pens. Mobile devices allow users to execute UI control elements via variety of modes.

Therefore, a need exists for an apparatus and method for processing UI control elements in a mobile device with a touch screen, via drawing gesture.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present are to address at least the above-mentioned problems and/or disadvantages and to provide at least the advantages described below. Accordingly, an aspect of the present invention is to provide a method that processes UI control elements in a mobile device with a touch screen, via drawing gestures, where a drawing pad is designed to provide a UI control function, so that the user can control the UI control elements in various shapes via the touch screen.

In accordance with an aspect of the present invention, a method for processing User Interface (UI) control elements in a mobile device with a touch screen is provided. The method includes displaying a checkbox, displaying a line according to a user's drawing gesture on the check box, enabling the checkbox if the length of the line is equal to or greater than a preset value, disabling, if the check box has previously been enabled, the checkbox by a user's touch gesture.

In accordance with another aspect of the present invention, a method for processing User Interface (UI) control elements in a mobile device with a touch screen is provided. The method includes displaying a clock UI, displaying lines according to user's drawing gestures on the clock UI, identifying the lengths of the drawn lines, and setting the number corresponding to the direction of a shorter line so as to correspond to the hour and the number corresponding to the direction of a longer line so as to correspond to the minute.

In accordance with another aspect of the present invention, a method for processing User Interface (UI) control elements in a mobile device with a touch screen is provided. The method includes displaying a clock UI displaying lines according to the user's drawing gestures on the clock UI identifying the order of drawn lines and setting a time to a timer in such a way that the number corresponding to the direction of the first drawn line is set to correspond to the beginning of time and the number corresponding to the direction of the following drawn line is set to correspond to the end of time.

In accordance with another aspect of the present invention, a method for processing User Interface (UI) control elements in a mobile device with a touch screen is provided. The method includes displaying a circle UI, displaying a circle line according to user's circle drawing gestures on the circle UI, identifying the number of circle drawing gestures to calculate a time interval, setting the time interval to a time for the timer, and reducing the length of the circle from the circle UI as time elapses.

In accordance with another aspect of the present invention, a method for processing User Interface (UI) control elements in a mobile device with a touch screen is provided. The method includes displaying a checkbox, displaying a line according to a user's drawing gesture on the check box, comparing the line to a preset value, determining whether to set the checkbox to an enabled mode according to the comparison of the line to the preset value.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will become more apparent from the following description taken in conjunction with the accompanying drawings, in which:

FIG. 1 illustrates a schematic block diagram of a mobile device according to an exemplary embodiment of the present invention;

FIG. 2 illustrates a flowchart that describes a method for remotely processing control elements in a mobile device, according to an exemplary embodiment of the present invention;

FIG. 3 illustrates a flowchart that describes a method for processing a control element of a checkbox according to an exemplary embodiment of the present invention such as, for example, the checkbox in the method shown in FIG. 2;

FIGS. 4A to 4C illustrate checkboxes that show the states according to drawing gestures, according to an exemplary embodiment of the present invention;

FIG. 5 illustrates a flowchart that describes a detailed step in which a time setting UI control element is processed according to an exemplary embodiment of the present invention such as, for example, step 223 of the method shown in FIG. 2;

FIGS. 6A and 6B illustrate a time setting UI control element according to an exemplary embodiment of the present invention;

FIG. 7 illustrates a flowchart that describes a method for processing a timer setting UI control element according to an exemplary embodiment of the present invention such as, for example, the time setting UI control element in the method shown in FIG. 2; and

FIGS. 8A and 8B illustrate a time setting UI control element according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The UI control element processing method according to exemplary embodiments of the present invention is achieved by a combination of a drawing pad and a UI control function in a mobile device. The method allows users to perform a drawing gesture to UI control elements. In the following description, the method will be explained, based on a UI control element for controlling a checkbox, a time set UI control element, and a timer setting UI control element.

A drawing checkbox is set by a drawing and determined according to whether it is set according to the length of the drawing line or the area of the drawing line. The mobile device user can release the set state of the checkbox, set by a drawing, by touching the set checkbox or rubbing it by his/her finger. Alternatively, the set state of the checkbox can be released when the user applies a drawing gesture to the checkbox. When the user successively draws different shapes in the checkbox, the previously drawn shape is removed from the checkbox and the newly drawn shape is applied thereto, such that the checkbox is set with the corresponding function.

A time setting UI control element is used to set a UI that displays time that the user sets in a setting mode. For example, time to be set is an alarm time or an appointment time. According to exemplary embodiments of the present invention, the UI may be shaped as a clock. Alternatively, UI may be shaped to receive a user's input time. If the UI is shaped as a clock UI, the user draws a long line and a short line to set time. According to such exemplary embodiments of the present invention, the mobile device recognizes the user's drawing lines in such a way that the short line corresponds to an hour hand and the long line corresponds to a minute hand. If the UI is a time input UI, the mobile device detects an image input to the UI as a letter and sets it to a time.

A timer setting UI control element is used to set UI that displays a timer that the user sets in a setting mode. According to exemplary embodiments of the present invention, the timer UI may be shaped as a clock UI or as a circle UI. The timer is a software system that sets the end of time intervals to be signaled (i.e., hour, minute, and second). For example, if the UI is a clock UI, the mobile device sets the location of the user's first drawing line as corresponding to the beginning of time and sets the location of the next drawn line as corresponding to the end of time. As another example, if the UI is a circle UI, the mobile device detects the number of drawing gestures and sets a time according to the detected number to a timer.

In the following description, the exemplary embodiments of the UI control element processing method according to exemplary embodiments of the present invention are explained in detail referring to the accompanying drawings.

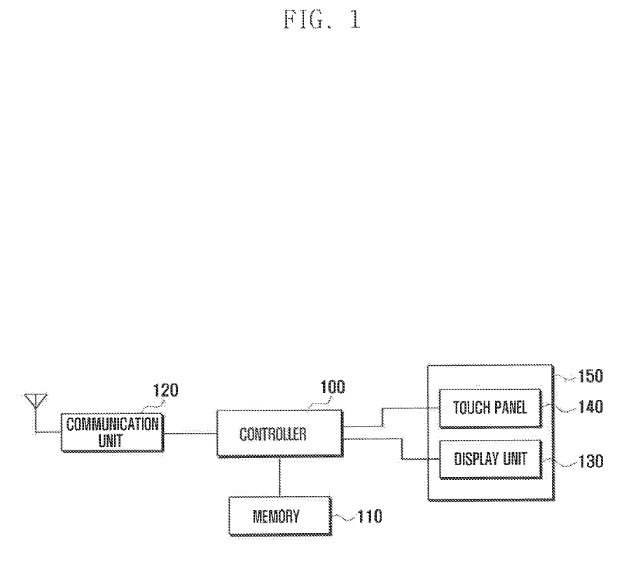

FIG. 1 illustrates a schematic block diagram of a mobile device according to an exemplary embodiment of the present invention.

Referring to FIG. 1, the mobile device includes a controller 100, a memory 110, a communication unit 120, and a touch screen 150.

The controller 100 controls the entire operation of the mobile device. The controller 100 controls remote control elements. For example, the controller 100 may be an application processor for executing application programs in the mobile device.

The memory 110 includes a program storage memory and a data storage memory. The program storage memory stores an Operating System (OS) of the mobile device and application programs. The data storage memory stores UI control elements and data created when the application programs are executed.

The communication unit 120 performs wireless communication with a base station or external systems. The communication unit 120 includes a transmitter for up-converting the frequency of signals to be transmitted and amplifying power of the signals and a receiver for low-noise amplifying received signals and down-converting the frequency of the received signals. The communication unit 120 further includes a modulator and a demodulator. The modulator modulates signals to be transmitted and transfers the modulated signals to the transmitter. The demodulator demodulates signals received via the receiver. The modulator-demodulator may be implemented with modules related to technologies, such as Long Term Evolution (LTE), Wideband Code Division Multiple Access (WCDMA), Global System for Mobile Communications (GSM), WiFi, Wireless Broadband (WiBro), Near Field Communication (NFC), Bluetooth, and the like. The controller 100 controls the entire operation of the mobile device.

The touch screen 150 includes a display unit 130 and a touch panel 140 which may be integrally formed. The display unit 130 displays UI control elements, according to the control of the controller 100, and displays lines that the user draws on the UI control elements. The display unit 130 may be implemented with a Liquid Crystal Display (LCD), an Organic Light Emitting Diode (OLED), or the like. In the exemplary embodiment of the present invention, it is assumed that the display unit 130 is an LCD. The touch panel 140 senses a user's drawing gestures and transfers the sensed signals to the controller 100.

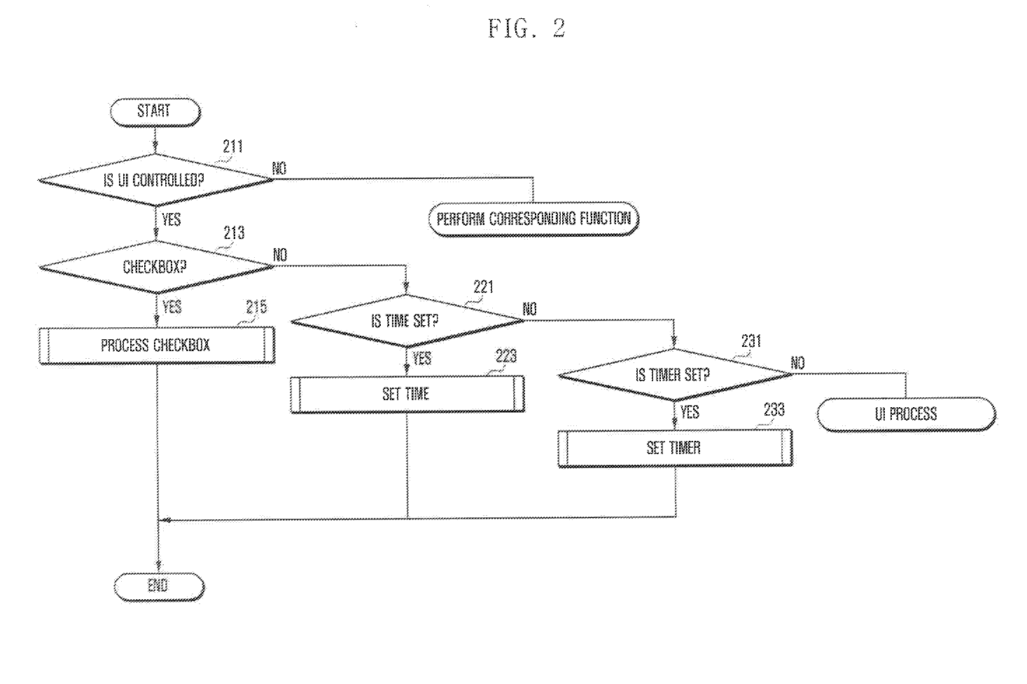

FIG. 2 illustrates a flowchart that describes a method for remotely processing control elements in a mobile device, according to an exemplary embodiment of the present invention.

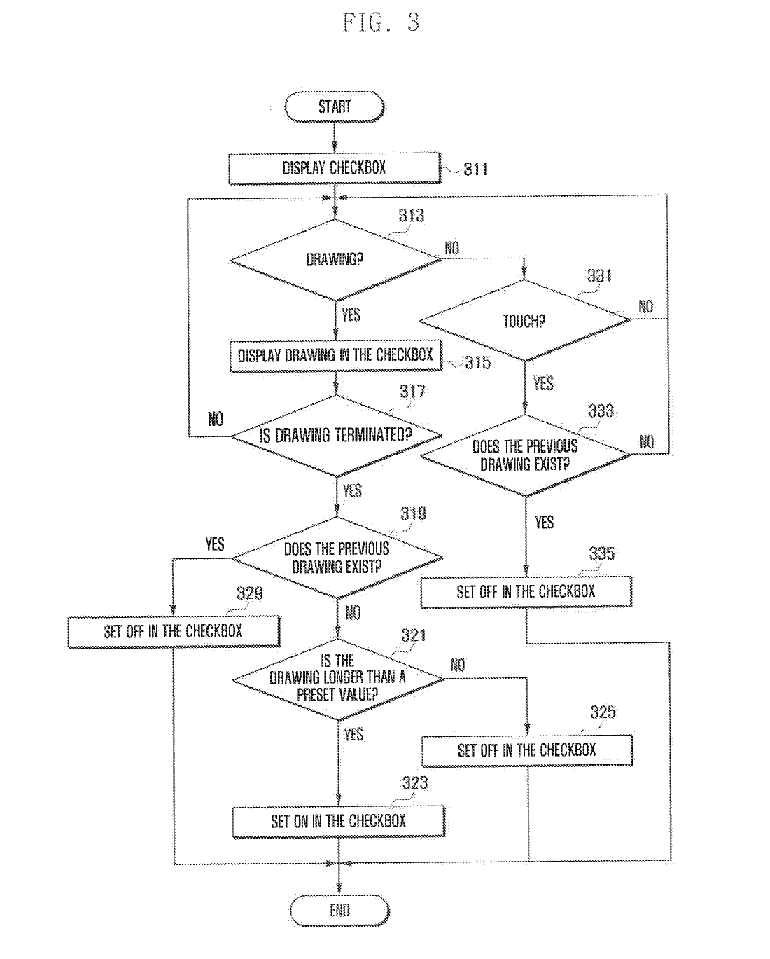

Referring to FIG. 2, when the mobile device is activated, the controller 100 determines whether it receives a command for displaying a UI control element at step 211. When the controller 100 has not received a command for displaying a UI control element at step 211, it performs the corresponding function. In contrast, when the controller 100 receives a command for displaying a UI control element at step 211, the controller 100 determines whether the UI control element to be displayed corresponds to a checkbox at step 213. When the controller 100 determines that the UI control element to be displayed corresponds to a checkbox at step 213, the controller 100 operatively displays a checkbox that is enabled or disenabled (disabled) as the user performs a drawing gesture at step 215, which is described in detail as follows, referring to FIG. 3.

FIG. 3 illustrates a flowchart that describes a method for processing a control element of a checkbox according to an exemplary embodiment of the present invention such as, for example, step 215 in the method shown in FIG. 2.

Referring to FIG. 3, the controller 100 controls the display unit 130 to display a checkbox at step 311. The checkbox may be a drawing checkbox. When the user performs a drawing gesture on the checkbox on the touch panel 140, the controller 100 detects the user's drawing gesture at step 313 and controls the display unit 130 to display a checkmark corresponding to the drawing gesture at step 315. After that, the controller 100 determines whether the user's drawing gesture is terminated on the touch panel 140 at step 317. When the controller 100 determines that the user's drawing gesture is terminated on the touch panel 140 at step 317, it determines whether a checkmark according to a previously drawn gesture has existed on the checkbox at step 319. As an example, this is a process to determine whether the currently performed drawing gesture is performed on the checkbox that has been enabled according to a previously drawn gesture. If the controller 100 determines that the user performs a drawing gesture on the checkbox that has been enabled according to the previously drawn gesture at step 319, the controller 100 disenables the checkbox at step 329. In that case, the controller 100 removes the previous checkmark from the display unit 130.

In contrast, if the controller 100 determines that the user performs a drawing gesture on the checkbox that has been disenabled at step 319, the controller 100 determines whether the length of the drawing line according to the drawing gesture is equal to or greater than a preset value at step 321. When the controller 100 determines that the length of the drawing line according to the drawing gesture is equal to or greater than a preset value at step 321, the controller 100 enables the checkbox (e.g., the controller operatively displays the drawing line on the checkbox) at step 323. In contrast, when the controller 100 determines that the length of the drawing line according to the drawing gesture is less than a preset value at step 321, the controller 100 disenables the checkbox at step 325. Therefore, when the user performs a drawing gesture on the checkbox displayed on the display unit 130, the controller 100 detects the user's drawing gesture. If the length of the drawing line according to the user's drawing gesture is equal to or greater than a preset value, the controller 100 displays the drawing line of the checkbox, thereby enabling the checkbox.

Meanwhile, when the user performs a touch operation on the checkbox that has been enabled according to a previously drawn gesture, instead of a drawing gesture, at steps 331 and 333, the controller 100 detects the user's touch and disenables the checkbox at step 335. That is, when the user applies a touch gesture or a scrub gesture to the checkbox that has been enabled according to a previously drawn gesture, the controller 100 detects the user's gesture. For example, at step 331, the controller 100 determines whether it has detected the user's touch. If the controller 100 determines that it has detected the user's touch, then at step 333 the controller determines whether there was a previously drawn gesture. After that, the controller 100 removes the checkmark from the checkbox on the display unit 130 and disenables it. In contrast, if the controller 100 determines that a touch is not detected at 331, then the process returns to step 313. Similarly, if the controller 100 determines that a previously drawn gesture does not exist, then the process returns to step 313.

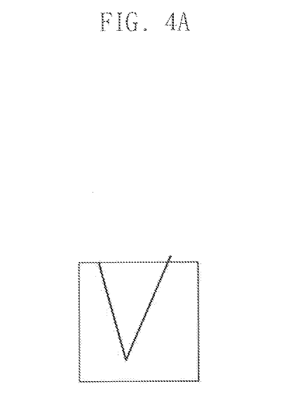

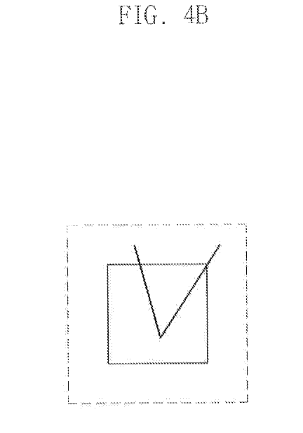

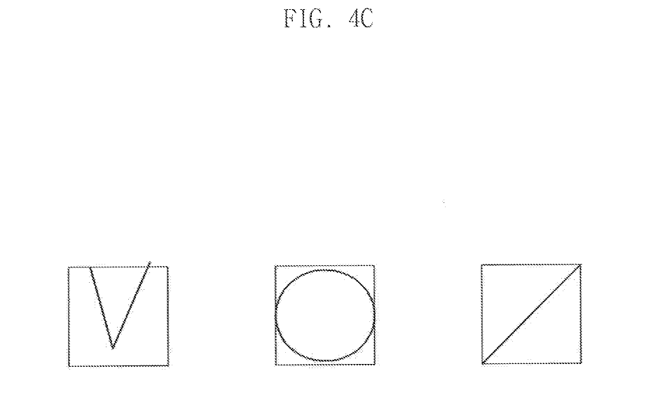

FIGS. 4A to 4C illustrate checkboxes that show the states according to drawing gestures, according to an exemplary embodiment of the present invention.

As shown in FIGS. 4A and 4B, the checkboxes are shown with checkmarks comprising lines that the user draws. When the user applies a touch gesture or a scrub gesture to the checkbox with a checkmark as shown in FIG. 4A or 4B, the controller 100 removes the checkmark from the checkbox, thereby making it empty, so that the checkbox is in a disenabled state. Alternatively, the checkbox may also be enabled in such a way that the user performs a drawing gesture via a stylus pen and accordingly creates a checkmark thereon. After that, the user scrubs the checkmark on the checkbox thereby removing the checkmark therefrom, or making the checkbox empty, such that the checkbox is in a disenabled state.

As shown in FIG. 4B, the rectangular checkbox is defined in such a way that the area is defined by solid lines and the drawing area larger than the area is defined by dashed lines that is actually invisible on the touch screen. The drawing area creates a checkmark on the touch screen that is that same as if the user describes it on a paper form. For example, the checkmark may extend over the checkbox area to the drawing area.

As shown in FIG. 4C, according to exemplary embodiments of the present invention, the checkbox may also be designed as various shapes, and accordingly enabled or disenabled with various types of checkmarks. Alternatively, a checkbox may be enabled with different types of checkmarks that vary in order during the enabled state.

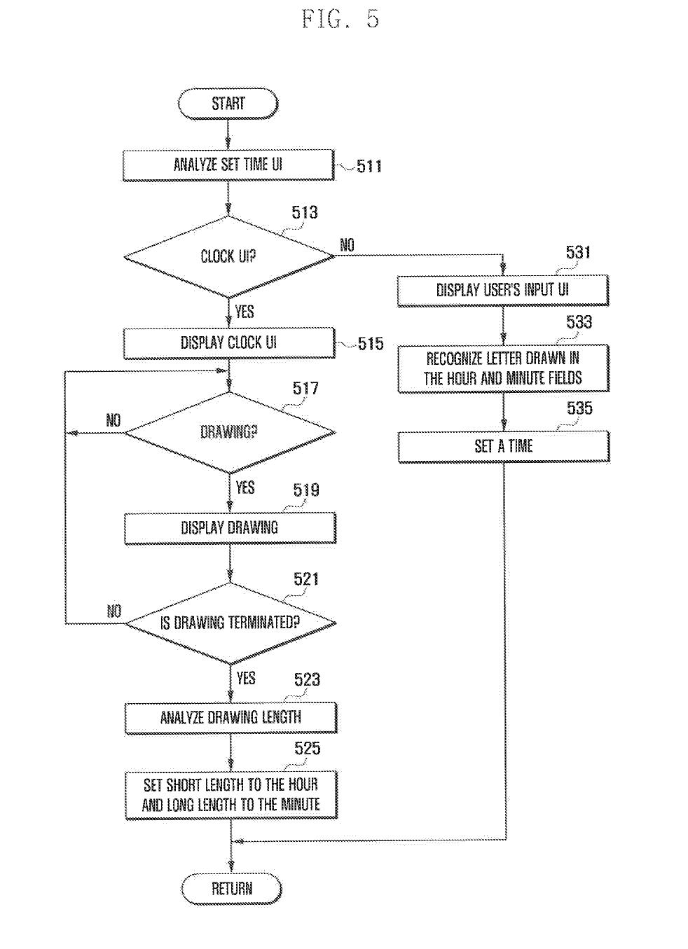

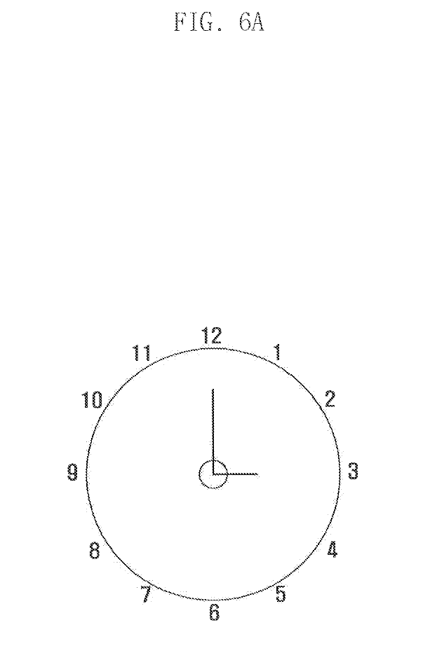

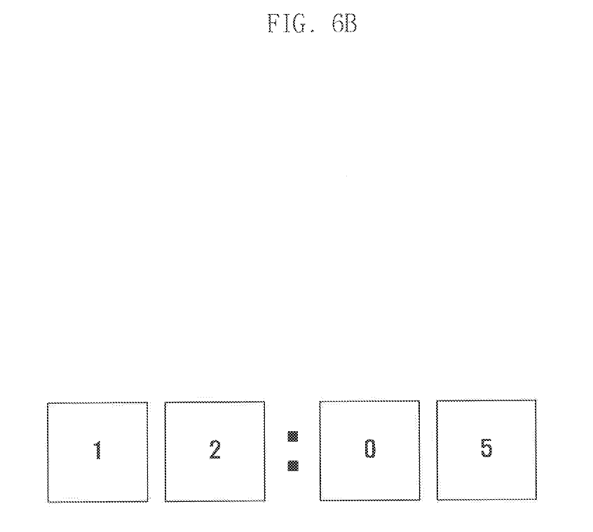

Referring back to FIG. 2, when the controller 100 determines that the UI control element to be displayed does not correspond to a checkbox at step 213, the controller 100 determines whether the UI control element is a time setting UI at step 221. When the controller 100 determines that the UI control element is a time setting UI at step 221, the controller 100 allows the user to set a time to the time setting UI by performing a drawing gesture at step 223, which is described in detail as follows, referring to FIG. 5 and FIGS. 6A and 6B.

FIG. 5 illustrates a flowchart that describes a detailed step in which a time setting UI control element is processed according to an exemplary embodiment of the present invention such as, for example, step 223 of the method shown in FIG. 2. FIGS. 6A and 6B illustrate a time setting UI control element according to an exemplary embodiment of the present invention. For example, FIG. 6A shows a clock UI, and FIG. 6B shows a user's input UI.

Referring to FIG. 5, when processing a remote control element to set a time, the controller 100 identifies the setting of a time setting UI control element at step 511. The mobile device includes a number of time setting UI control elements, such that the user can set a corresponding time setting UI control element in a setting mode. In the following description, it is assumed that the time setting UI control element is a clock UI as shown in FIG. 6A and a user's input UI as shown in FIG. 6B. A time setting operation corresponds to an operation in which the user sets an hour and a minute, an alarm time, an appointment time, or the like.

The controller 100 determines whether the time setting UI control element is set to a clock UI at step 513. When the controller 100 determines that the time setting UI control element has been set to a clock UI at step 513, the controller 100 operatively displays the clock UI as shown in FIG. 6A at step 515. The controller 100 determines whether the user applies a drawing gesture to the clock UI at step 517. When the controller 100 determines that the user applies a drawing gesture to the clock UI at step 517, the controller 100 operatively displays a line according to a drawing gesture on the clock UI on the display unit 130 at step 519. After that, the controller 100 determines whether the user's drawing gesture is terminated at step 521. When the controller 100 determines that the user's drawing gesture is not terminated at step 521, the controller 100 allows the user to perform a drawing gesture at step 517. In contrast, when the controller 100 determines that the user's drawing gesture is terminated at step 521, the controller 100 identifies the lengths of the lines according to the drawing gestures at step 523. The controller 100 sets a shorter line as an hour hand and also the number corresponding to the direction of the shorter line to the hour; and sets a longer line as a minute hand and also the number corresponding to the direction of the longer line to the minute, thereby setting a time at step 525.

As such, if the time setting UI control element has been set to a clock UI, the user draws two lines, one shorter than the other, on the clock UI as shown in FIG. 6A. The controller 100 indentifies lengths of the two lines placed on the clock UI. The controller 100 sets the number corresponding to the direction of the short line to the hour and the number corresponding to the direction of the long line to the minute, thereby 3 o'clock for example as shown in FIG. 6A. If the user intends to set A.M. or P.M. to the set time, the user can select A.M. or P.M. in the clock UI, thereby setting a time with A.M. or P.M. Alternatively, the user may draw a circle and then set a time as described above, or vice versa. In that case, this operation may be a process to set P.M. to the time.

In contrast, when the controller 100 determines that the time setting UI control element has been set to a user's input UI at step 513, the controller 100 operatively displays the user's input UI as shown in FIG. 6B at step 531. The user's input UI includes fields where the user inputs the hour and the minute. When the user inputs the hour and the minute to the user's input UI according to the drawing gestures, the controller 100 detects the user's input letter images and creates letter data (i.e., number data) at step 533. After that, the controller 100 sets the numbers as a time and displays the time on the display unit 130 as shown in FIG. 6B at step 535.

As described above, the time setting UI control element can be set to a clock UI as shown in FIG. 6A or a user's input UI as shown in FIG. 6B. Time can be set in such a way that the user inputs numbers via a keypad or drags numbers up or down. As shown in FIG. 6A, time can be set in such a way that the user draws lines corresponding to hour and minute hands and the controller 100 automatically detects the drawing lines and the lengths, calculates the hour and the minute, and sets it to a time. Likewise, as shown in FIG. 6B, the user draws letters on the user's input UI including the rectangular input fields. In that case, the controller 100 detects the drawing images as number data and inputs corresponding numbers to the time field and date field.

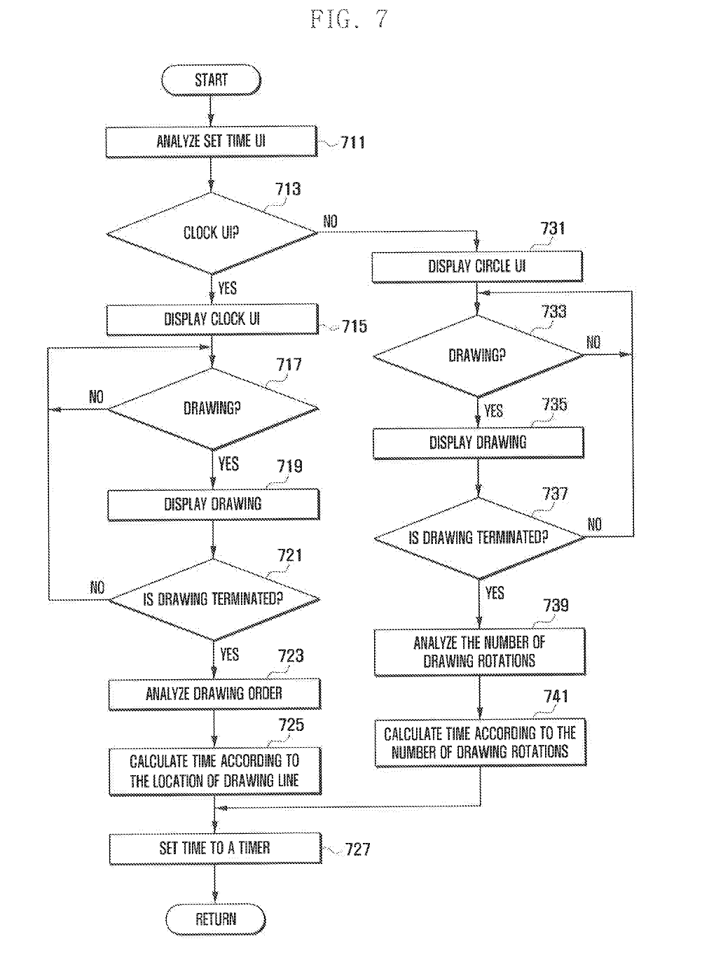

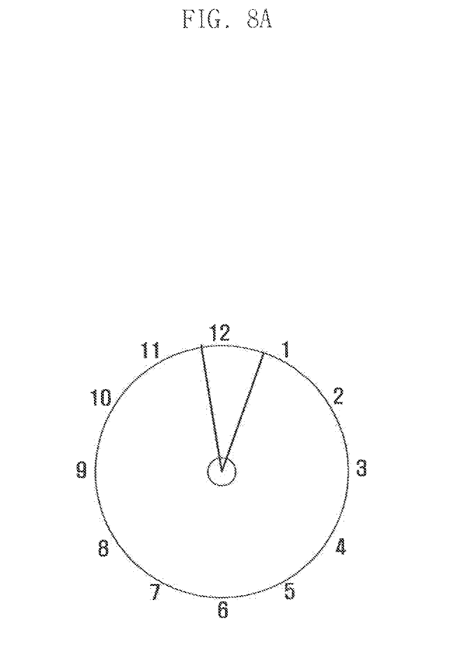

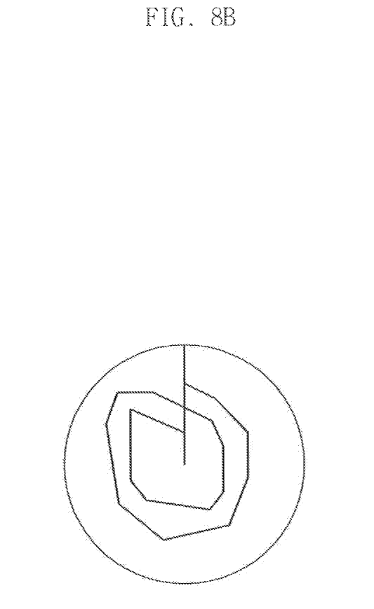

Referring back to FIG. 2, when the controller 100 determines that the UI control element is not a time setting UI at step 221, the controller 100 determines whether the UI control element is a timer setting UI at step 231. When the controller 100 determines that the UI control element is a timer setting UI at step 231, the controller 100 allows the user to perform a drawing gesture on the timer setting UI control element and sets a time at step 233, which is described in detail referring to FIG. 7 and FIGS. 8A and 8B. In contrast, when the controller 100 determines that the UI control element is not a timer setting UI, the process proceeds to perform a UI process.

FIG. 7 illustrates a flowchart that describes a method in which a timer setting UI control element is processed according to an exemplary embodiment of the present invention such as, for example, the time setting UI control element in the method shown in FIG. 2. FIGS. 8A and 8B illustrate a time setting UI control element according to an exemplary embodiment of the invention. For example, FIG. 8A shows a clock UI and FIG. 8B shows a circle UI.

Referring to FIG. 7, when processing a remote control element to set a timer, the controller 100 identifies the setting of a timer setting UI control element at step 711. According to exemplary embodiments of the present invention, the mobile device includes a number of timer setting UI control elements, such that the user can set a corresponding timer setting UI control element in a setting mode. In the following description, it is assumed that the timer setting UI control element is a clock UI as shown in FIG. 8A and a circle UI as shown in FIG. 8B. A timer setting operation corresponds to an operation in which the user sets the end of time intervals (i.e., hour, minute or second), which differs from the setting of a time.

The controller 100 determines whether the timer setting UI control element is set to a clock UI at step 713. When the controller 100 determines that the timer setting UI control element has been set to a clock UI at step 713, the controller 100 operatively displays the clock UI as shown in FIG. 8A at step 715. The controller 100 determines whether the user applies a drawing gesture to the clock UI at step 717. When the controller 100 determines that the user applies a drawing gesture to the clock UI at step 717, the controller 100 operatively displays the drawing result according to a drawing gesture on the clock UI on the display unit 130 at step 719. After that, the controller 100 determines whether the user's drawing gesture is terminated at step 721. When the controller 100 determines that the user's drawing gesture is not terminated at step 721, the controller 100 allows the user to perform a drawing gesture at step 717. In contrast, when the controller 100 determines that the user's drawing gesture is terminated at step 721, the controller 100 identifies the order of the lines that the user has drawn at step 723. According to exemplary embodiments of the present invention, the controller 100 calculates the time interval (e.g., hour, minute, or second) according to the location of the lines drawn on the clock UI at step 725, and sets the time intervals to the end of time intervals of the timer at step 727.

As such, if the timer setting UI control element has been set to a clock UI, the user draws two or more lines on the clock UI as shown in FIG. 8A. When the clock UI shows a time as shown in FIG. 8A, the controller 100 identifies the order of the drawn lines. The controller 100 sets the number corresponding to the direction of the first drawn line to the beginning of time and the number corresponding to the direction of the following drawn line to the end of time.

In contrast, when the controller 100 determines that the timer setting UI control element has not been set to a clock UI (e.g., when the controller 100 determines that the timer setting has been set to a circle UI) at step 713, the controller 100 operatively displays the circle UI as shown in FIG. 8B at step 731. When the user performs a circle drawing gesture on the circle UI as shown in FIG. 8B, the controller 100 detects it at step 733 and displays a circular line at step 735. When the user stops drawing a circle at step 737, the controller 100 identifies the number of circle drawing gestures on the circle UI at step 739. After that, the controller 100 calculates the time interval (e.g., hour, minute, or second) according to the number of circle drawing gestures at step 741, and then sets the calculated time interval to a time for the timer as step 727. In contrast, if the controller 100 determines that the drawing is not terminated at step 737, then the process returns to step 733. Similarly, if the controller 100 determines that the user is not performing a circle drawing gesture on the circle UI, the process returns to step 737 (e.g., the controller 100 monitors for a circle drawing gesture input by the user).

As described above, when the user draws a circle on the circle UI in order to set a time to the timer, the controller 100 calculates the number of circle drawing gestures based on the corresponding line of the circle UI and sets it to a time of the timer. For example, if one revolution of a circle drawing gesture corresponds to 24 hours, 60 minutes, and 60 seconds with respect to hour, minute, and second lines, or hand, respectively. When a time is set to the timer according to the number of circle drawing gestures, the controller 100 reduces the length of rotated line as shown in FIG. 8B, thereby showing time elapsing.

As described above, the UI control element processing method according to exemplary embodiments of the present invention allows users to draw a variety of shapes or to write letters on the touch screen of a mobile device, in order to control UI elements, so that the user can set/add meanings to the drawings and also set the speed or time to the UI elements.

While the invention has been shown and described with reference to certain exemplary embodiments thereof, it will be understood by those skilled in the art that various changes in form and details may be made therein without departing from the spirit and scope of the invention as defined in the appended claims and their equivalents.

What is claimed is:

1. A method for processing User Interface (UI) control elements in a mobile device with a touch screen, comprising:
displaying a checkbox;
displaying a line according to a user's drawing gesture on the check box;
enabling the checkbox if the length of the line is equal to or greater than a preset value;
disabling, if the check box has previously been enabled, the checkbox by a user's touch gesture.

2. The method of claim 1, further comprising:
determining whether the checkbox includes a previously drawn line; and
removing, if the checkbox includes a previously drawn line, the previously drawn line from the checkbox and disabling the checkbox.

3. The method of claim 2, further comprising:
disabling, if the length of the line in the check box is less than a preset value, the checkbox.

4. The method of claim 1, further comprising:
processing a time setting UI,
wherein the processing of the time setting UI comprises:
displaying a clock UI;
displaying lines according to user's drawing gestures on the clock UI;
identifying the lengths of the drawn lines; and
setting the number corresponding to the direction of a shorter line to correspond to the hour and setting the number corresponding to the direction of a longer line to correspond to the minute.

5. The method of claim 4, further comprising:
processing a user's input UI with hour and minute input fields,
wherein the processing of the user's input UI comprises:
displaying a user's input UI; and
detecting a user's drawing gesture input to the user's input UI, and converting the user's drawing gesture input to number data; and
setting the number data to the hour and the minute.

6. The method of claim 1, further comprising:
processing a timer setting UI,
wherein the processing of the timer setting UI comprises:
displaying a clock UI;
displaying lines according to the user's drawing gesture on the clock UI;
identifying the order of drawn lines; and
setting a time to a timer in such a way that the number corresponding to the direction of the first drawn line is set to correspond to the beginning of time and the number corresponding to the direction of the following drawn line is set to correspond to the end of time.

7. The method of claim 6, further comprising:
processing a circle UI,
wherein the processing of the circle UI comprises:
displaying the circle UI;
displaying a circle line according to user's circle drawing gesture on the circle UI;
identifying the number of circle drawing gestures to calculate a time interval;
setting the time interval to a time for the timer; and
reducing the length of the circle from the circle UI as time elapses.

8. The method of claim 1, wherein the disabling of the checkbox by the user's touch gesture comprises:
setting the checkbox to a mode in which the checkbox is not enabled.

9. A method for processing User Interface (UI) control elements in a mobile device with a touch screen, comprising:
displaying a clock UI;
displaying lines according to user's drawing gestures on the clock UI;
identifying the lengths of the drawn lines; and
setting the number corresponding to the direction of a shorter line so as to correspond to the hour and the number corresponding to the direction of a longer line so as to correspond to the minute.

10. The method of claim 9, further comprising:
processing a user's input UI with hour and minute input fields,
wherein the processing of the user's input UI comprises:
displaying the user's input UI; and
detecting a user's drawing gesture input to the user's input UI, and converting the user's drawing gesture input to number data; and
setting the number data to the hour and the minute.

11. The method of claim 9, further comprising:
processing a timer setting UI,
wherein the processing of the timer setting UI comprises:
displaying a clock UI;
displaying lines according to the user's drawing gestures on the clock UI;
identifying the order of drawn lines; and
setting a time to a timer in such a way that the number corresponding to the direction of the first drawn line is set to correspond to the beginning of time and the number corresponding to the direction of the following drawn line is set to correspond to the end of time.

12. The method of claim 11, further comprising:
processing a circle UI,
wherein the processing of the circle UI comprises:
displaying the circle UI;
displaying a circle line according to user's circle drawing gestures on the circle UI;
identifying the number of circle drawing gestures to calculate a time interval;
setting the time interval to a time for the timer; and
reducing the length of the circle from the circle UI as time elapses.

13. A method for processing User Interface (UI) control elements in a mobile device with a touch screen, the method comprising:
displaying a checkbox;
displaying a line according to a user's drawing gesture on the check box;
comparing the line to a preset value; and
determining whether to set the checkbox to an enabled mode according to the comparison of the line to the preset value.

14. The method of claim 13, further comprising:
determining whether the checkbox includes a previously drawn line; and
removing, if the checkbox includes a previously drawn line, the previously drawn line from the checkbox and setting the checkbox to a mode in which the checkbox is not enabled.

15. The method of claim 14, further comprising:
setting the checkbox to a mode in which the checkbox is not enabled if the length of the line is less than a preset value.

16. The method of claim 13, further comprising:
processing a time setting UI,
wherein the processing of the time setting UI comprises:
displaying a clock UI;
displaying lines according to user's drawing gestures on the clock UI;
identifying the lengths of the drawn lines; and
setting the number corresponding to the direction of a shorter line to correspond to the hour and setting the number corresponding to the direction of a longer line to correspond to the minute.

17. The method of claim 16, further comprising:
processing a user's input UI with hour and minute input fields,
wherein the processing of the user's input UI comprises:
displaying a user's input UI;
detecting a user's drawing gesture input to the user's input UI, and converting the user's drawing gesture input to number data; and
setting the number data to the hour and the minute.

18. The method of claim 13, further comprising:
processing a timer setting UI,
wherein the processing of the timer setting UI comprises:
displaying a clock UI;
displaying lines according to the user's drawing gesture on the clock UI;
identifying the order of drawn lines; and
setting a time to a timer in such a way that the number corresponding to the direction of the first drawn line is set to correspond to the beginning of time and the number corresponding to the direction of the following drawn line is set to correspond to the end of time.

19. The method of claim 18, further comprising:
processing a circle UI,
wherein the processing of the circle UI comprises:
displaying the circle UI;
displaying a circle line according to user's circle drawing gesture on the circle UI;
identifying the number of circle drawing gestures to calculate a time interval;
setting the time interval to a time for the timer; and
reducing the length of the circle from the circle UI as time elapses.
